(19) United States
(12) Patent Application Publication
(10) Pub. No.: US 2007/0024497 A1
(43) Pub. Date: Feb. 1, 2007

(54) Navigation signal receiving apparatus and navigation signal receiving method

(75) Inventors: Tomoya Shibata, Tokyo (JP); Hiroaka Maeda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC TOSHIBA Space Systems, Ltd.

(21) Appl. No.: 11/493,708

(22) Filed: Jul. 27, 2006

(30) Foreign Application Priority Data
Jul. 29, 2005 (JP) 219759/2005

(51) Int. Cl. G01S 5/14

(52) U.S. Cl. 342/357.02

(57) ABSTRACT

A navigation signal receiving apparatus for determining a position based on a navigation signal sent from an artificial satellite, the apparatus includes (a) a positioning unit sampling range data from the navigation signal at a first time interval, (b) an averaging unit averaging the range data at a second time interval of a lower rate than the first time interval, and (c) a positioning process unit calculating a position based on the range data averaged by the averaging unit.

### BACKGROUND OF THE INVENTION

1. Field of the Invention

The present invention relates to a navigation signal receiving apparatus and a navigation signal receiving method, and more particularly to a navigation signal receiving apparatus and a navigation signal receiving method having an object of reducing multipath errors. The present invention can be broadly applied to navigation signal receiving apparatuses such as a GPS (Global Positioning System) receiver, a GALILEO receiver or a GLONASS (Global Navigation Satellite System) receiver.

2. Description of the Related Art

Navigation signal receiving apparatuses serve to receive a navigation signal from a satellite, such as a GPS satellite, and thereby measure a distance between the source of the signal and the navigation signal receiving apparatus. However, in urban areas or the like, in addition to a direct wave from the satellite, multipath waves generated by being reflected by the buildings, the ground or the like arrive at the navigation signal receiving apparatus. Accordingly, in the navigation signal receiving apparatus, the direct wave and multipath waves are combined to be processed. Consequently, the navigation signal receiving apparatus calculates a distance different from an original distance, thus causing a multipath error to occur.

Therefore, there have hitherto been developed various techniques for reducing multipath errors. Related Art's Document 1 (Japanese Patent Laid-Open No. 2000-266836, particularly pp. 6 to 7, FIG. 2, FIG. 3) proposes a technique for preventing positioning errors caused by multipath occurring when the moving speed of a mobile station, such as a car navigation apparatus, is low. Related Art's Document 1 focuses attention on a fact that the fluctuating cycle (fading bandwidth) of waves generated when a radio wave from the GPS satellite is reflected, is proportional to the moving speed of the mobile station. Furthermore, the Related Art's Document 1 also focuses attention on the relationship between positioning error caused by multipath and the loop bandwidth of DLL (Delay Lock Loop). Thus, the Related Art's Document proposes a technique which makes variable the loop bandwidth of DLL and at the same time, narrows the loop bandwidth of DLL to thereby prevent positioning errors caused by multipath generated when the moving speed of the mobile station is low. Accordingly, Related Art's Document 1 proposes compensating for multipath without raising sampling frequency and at the same time, without adding hardware.

However, there are limits to known multipath error reduction techniques such as one described in Related Art's Document 1. Specifically, if the intensity of multipath waves is about one-tenth that of the direct wave, when a positioning technique with no multipath error reduction technique is employed, a multipath error having a maximum value of about 15 m occurs; even when a positioning technique using the best possible multipath error reduction technique is employed, a multipath error of about 1.5 m remains.

The reason for this is that the relationship between multipath error and multipath length exhibits oscillating behavior. The expression “multipath length” means a measured length extended relative to a distance when received directly from the satellite, as a result of the navigation signal reflected by the buildings, the ground or the like. FIG. 4 is a graph showing a typical relationship between multipath error and multipath length. The absciss a indicates multipath length: the ordinate indicates multipath error. In FIG. 4, there are shown two typical examples. In Typical Example 1, as represented by a solid line, as multipath length increases, the amplitude of multipath error exhibiting oscillating behavior becomes larger. In Typical Example 2, as represented by a broken line, irrespective of multipath length,the amplitude of multipath error exhibiting oscillating behavior is almost constant. As shown in FIG. 4, in either case, multipath errors have a characteristic of oscillating according to multipath length.

However, in the conventional multipath reduction techniques, any measure against multipath error exhibiting such oscillating behavior is not considered. Consequently, according to the related art, affected by such oscillation, multipath errors cannot be reduced to 1.5 m or smaller, as described above.

### SUMMARY OF THE INVENTION

In view of the foregoing and other exemplary problems, drawbacks, and disadvantages of the related art methods and structures, exemplary feature of the present invention is to provide a navigation signal receiving apparatus and a navigation signal receiving method for reducing multipath error.

A navigation signal receiving apparatus according to the present invention for determining a position based on a navigation signal sent from an artificial satellite, the apparatus includes (a) a positioning unit sampling range data from the navigation signal at a first time interval, (b) an averaging unit averaging the range data at a second time interval of a lower rate than the first time interval, and (c) a positioning process unit calculating a position based on the range data averaged by the averaging unit.

A navigation signal receiving method according to the present invention for determining a position based on a navigation signal sent from an artificial satellite, the method includes (a) sampling range data from the navigation signal at a first time interval, (b) averaging the range data at a second time interval of a lower rate than the first time interval, and (c) calculating a position based on the range data averaged.

In this manner, in the navigation signal receiving apparatus and the navigation signal receiving method according to the present invention, range data is sampled at a first time interval and then averaged at a second time interval of a lower rate than the first time interval. Thus, according to the present invention, improvement of accuracy made by the averaging operation is possible, because the number of samples of range data is increased by speeding up, by use of a first time interval, the sampling period of a navigation signal sent from the satellite, and the range data with the number of samples thereof increased is averaged by use of a second time interval. Consequently, the navigation signal receiving apparatus and navigation signal receiving method according to the present invention has an advantageous effect of being capable of surely reducing effects of multipath errors exhibiting oscillating behavior.

### BRIEF DESCRIPTION OF THE DRAWINGS

The exemplary aspects, features and advantages of the present invention will become more apparent from the following detailed description when taken in conjunction with the accompanying drawings wherein:

FIG. 1 is a block diagram showing a schematic configuration of a navigation signal receiving apparatus according to Embodiment 1 of the present invention;

FIG. 2 is a block diagram showing an exemplary internal configuration of the navigation signal receiving apparatus shown in FIG. 1;

FIG. 3A is a conceptual diagram in schematic form showing the operation of a high-rate range measurement circuit shown in FIG. 2;

FIG. 3B is a conceptual diagram in schematic form showing the operation of an averaging circuit shown in FIG. 2; and

FIG. 4 is a graph showing a typical relationship between multipath error and multipath length.

### DETAILED DESCRIPTION OF THE EXEMPLARY ASPECTS

Exemplary aspects for carrying out the present invention will be described in detail below with reference to the drawing. The exemplary aspects described below show only illustrative examples in understanding the present invention, and the claims of the invention are not limited to these exemplary aspects.

A configuration of a navigation signal receiving apparatus according to Embodiment 1 of the present invention will be described below in detail with reference to the drawings.

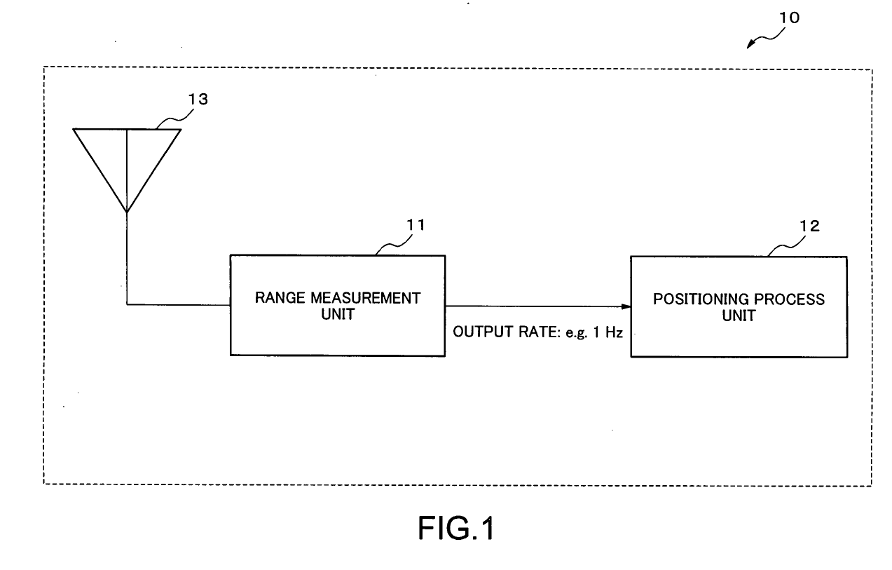

FIG. 1 is a block diagram showing a schematic configuration of a navigation signal receiving apparatus according to Embodiment 1 of the present invention. The navigation signal receiving apparatus 10 is shown as an example in which the apparatus operates, as a GPS receiver, according to positioning information sent from a GPS (Global Positioning System) satellite acting as an artificial satellite. The navigation signal receiving apparatus 10 includes a range measurement unit 11, a positioning process unit 12 and an antenna 13. The antenna 13 receives a navigation signal including range data sent from the GPS satellite. The range measurement unit 11 samples the received navigation signal at a given rate to extract the range data. The positioning process unit 12 calculates position using the extracted range data. Referring to FIG. 1, by way of example, output rate is set to 1 Hz. However, for the purpose of making it easier to understand the present invention, a typical case is shown here; the present invention is not limited only to this value.

In Embodiment 1, there is shown an example in which a navigation signal is received from a GPS satellite. However, the present invention is not limited only to the GPS receiver, and similarly applicable to navigation signal receiving apparatuses such as a GALILEO receiver or a GLONASS (Global Navigation Satellite System) receiver.

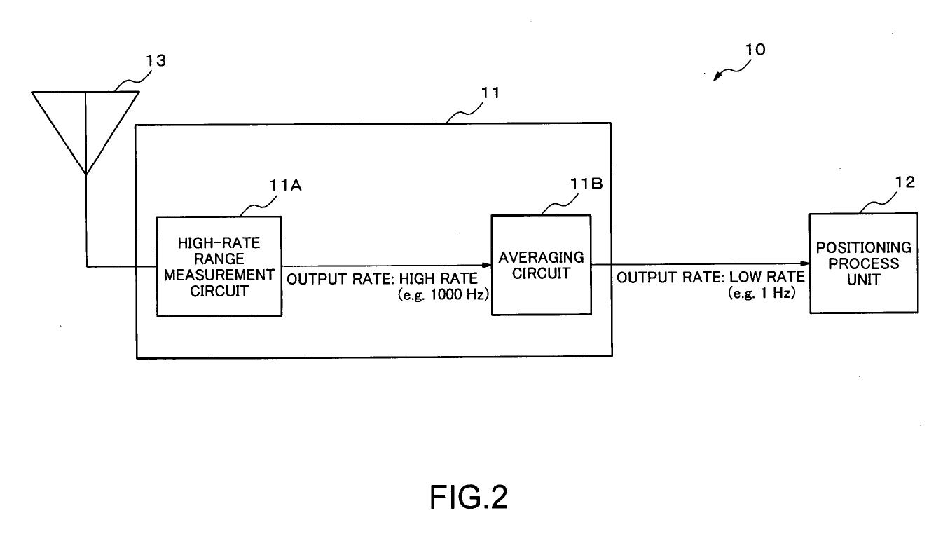

FIG. 2 is a block diagram showing an exemplary internal configuration of the navigation signal receiving apparatus 10 shown in FIG. 1. As shown in FIG. 2, the range measurement unit 11 includes a high-rate range measurement circuit 11A and an averaging circuit 11B.

Referring to FIG. 2, the high-rate range measurement circuit 11A samples range data containing multipath errors exhibiting oscillating behavior at a high-rate time interval, and outputs the sampled data as high-rate range data to the averaging circuit 11B. Meanwhile, the averaging circuit 11B averages at a low-rate time interval the high-rate range data outputted at a high rate from the high-rate range measurement circuit 11A, and outputs the averaged data as low-rate range data to the positioning process unit 12. The positioning process unit 12 calculates position using the low-rate range data.

Referring to FIG. 2, by way of example, high-rate time interval is set to 1,000 Hz, and low-rate time interval is set to 1 Hz. However, for the purpose of making it easier to understand the present invention, a typical case is shown here; the present invention is not limited only to these values. For example, high-rate time interval can be set to several hundreds Hz or greater, and low-rate time interval can be set to 10 Hz or smaller.

The internal configurations of the high-rate range measurement circuit 11A, the averaging circuit 11B and the positioning process unit 12 shown in FIG. 2 maybe commonly-used ones, so an explanation thereof is omitted here.

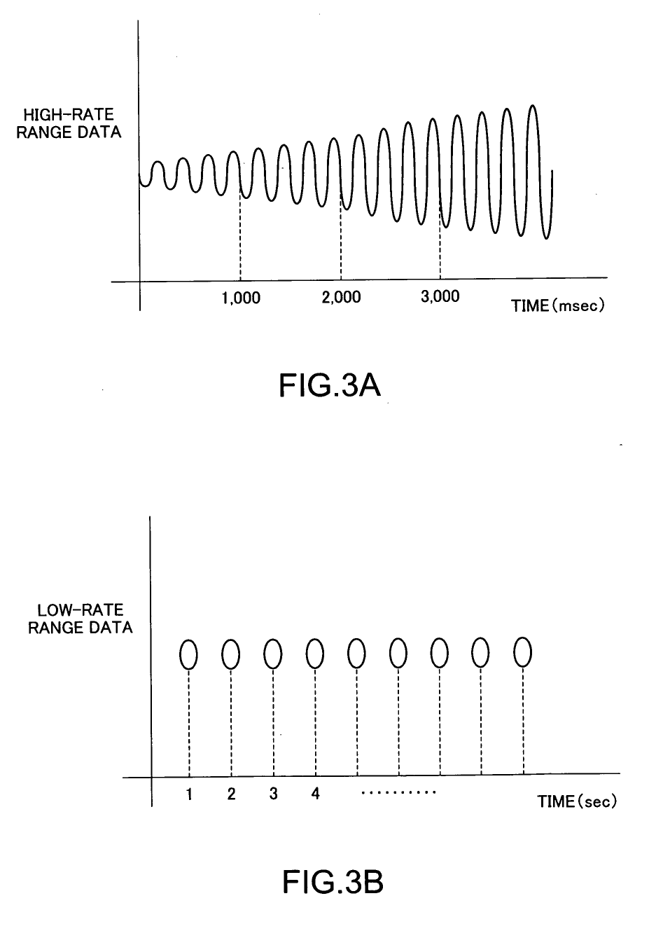

The operation of the high-rate range measurement circuit 11A and the averaging circuit 11B in the range measurement unit 11 shown in FIG. 2 will be described with reference to FIGS. 3A and 3B.

FIGS. 3A and 3B are conceptual diagrams in schematic forms showing the operation of the high-rate range measurement circuit 11A and the averaging circuit 11B shown as Embodiment 1 of the present invention in FIG. 2. The high-rate range measurement circuit 1A samples a navigation signal including range data sent from the antenna 13, at a high speed at a predetermined high-rate time interval. In FIG. 2, as an exemplary high rate, a period of 1000 Hz, i.e., once per 1 msec is employed. Thus, as shown in FIG. 3A, the high-rate range data outputted from the high-rate range measurement circuit 11A to the averaging circuit 11B is an oscillating signal as a result of being affected by multipath errors.

Meanwhile, the averaging circuit 11B applies an averaging processing at a predetermined low-rate time interval to the high-rate range data outputted at a high-rate time interval from the high-rate range measurement circuit 11A. In FIG. 2, as an exemplary low rate, a period of 1 Hz, i.e., once per 1 sec is employed. Therefore, in the example of FIG. 2, in the averaging circuit 11B, an averaging processing is performed for each unit of 1000 samples of the high-rate range data. Accordingly, as shown in FIG. 3B, a signal stabilized by the averaging processing is generated from the oscillating signal containing multipath errors as shown in FIG. 3A. Then, this low-rate range data is outputted to the positioning process unit 12.

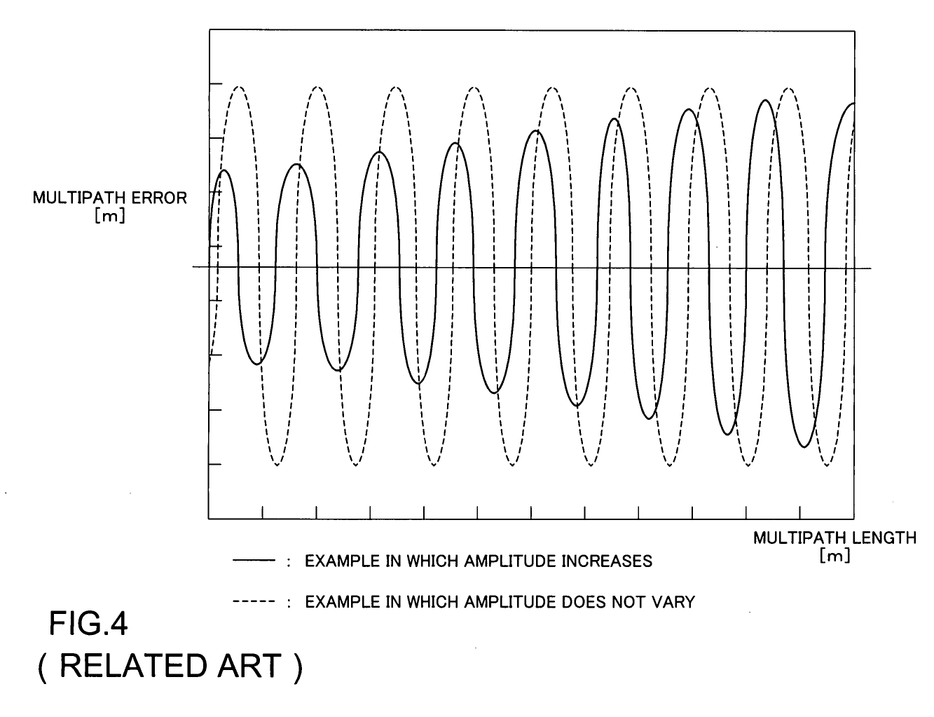

In this manner, according to Embodiment 1 of the present invention, after being once sampled at a high-rate time interval, high-rate range data is averaged at a low-rate time interval and the averaged low-rate range data is outputted to the positioning process unit 12. Accordingly, according to Embodiment 1 of the present invention, as shown in FIG. 4, effects of multipath errors exhibiting oscillating behavior relative to multipath length can be reduced. Thus, Embodiment 1 of the present invention makes it possible to calculate a position based on more accurate range data.

Here, the high-rate time interval applied to the high-rate range measurement circuit 11A is preferable to speed up, in order to raise the effect of averaging processing in the averaging circuit 11B. This is because, when the number of samples of range data to be averaged is increased, reliability can be increased accordingly. Further, to raise the effect thereof, the bandwidth of signal tracking control is set wider. Accordingly, the number of samples of high-rate range data increases. Meanwhile, the low-rate time interval applied to the averaging circuit 11B is preferably reduced to a time interval which allows real-time processing. With the above arrangement, accurate range data with effects of multipath errors reduced can be obtained at a practical time interval.

Furthermore, it is assumed that the navigation signal receiving apparatus 10 of Embodiment 1 of the present invention is applied to navigation of mobile stations such as an automobile. The low-rate time interval in the averaging circuit 11B is preferably set to a time interval used for navigation which allows real-time processing. Mean while, the high-rate time interval in the high-rate range measurement circuit 11A is preferably set to a time interval which makes obtainable the number of samples capable of reducing effects of multipath errors exhibiting oscillating behavior according to multipath length. With the above arrangement, accurate range data with effects of multipath errors reduced can be obtained at a time interval used for navigation which allows real-time processing.

As described above, according to Embodiment 1 of the present invention, the number of samples of range data is increased to improve the averaging effect by speeding up measurement in the range measurement circuit and disposing the averaging circuit at the rear stage thereof. Accordingly, Embodiment 1 of the present invention has an advantageous effect of surely reducing effects of multipath errors exhibiting oscillating behavior. Thus, Embodiment 1 of the present invention has an advantageous effect of making it possible to calculate a position based on more accurate range data.

Also, according to Embodiment 1 of the present invention, after being sampled at a high speed, range data is averaged to be outputted. Thus, there is provided an advantageous effect in that, in car navigation, mobile navigation and the like, range data can be obtained at a practical time interval which allows real-time processing.

Embodiment 1 of the present invention can be broadly applied to navigation signal receiving apparatuses such as a GPS receiver, a GALILEO receiver or a GLONASS receiver.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

Further, the inventor's intent is to retain all equivalents of the claimed invention even if the claims are amended later during prosecution.

What is claimed is:

1. A navigation signal receiving apparatus for determining a position based on a navigation signal sent from an artificial satellite, the apparatus comprising:
a positioning unit sampling range data from the navigation signal at a first time interval;
an averaging unit averaging the range data at a second time interval of a lower rate than the first time interval; and
a positioning process unit calculating a position based on the range data averaged by the averaging unit.

2. The navigation signal receiving apparatus according to claim 1, wherein the first time interval is a time interval that reduces positioning errors caused by multipath waves exhibiting oscillating behavior.

3. The navigation signal receiving apparatus according to claim 1, wherein the second time interval is a time interval that allows a mobile station to be tracked.

4. The navigation signal receiving apparatus according to claim 3, wherein the mobile station is used for navigation.

5. The navigation signal receiving apparatus according to claim 1, wherein the first time interval is several hundreds Hz or greater.

6. The navigation signal receiving apparatus according to claim 1, wherein the second time interval is 10 Hz or smaller.

7. The navigation signal receiving apparatus according to claim 1, wherein the first time interval is several tens times or greater than the second time interval.

8. The navigation signal receiving apparatus according to claim 1, further comprising:
an antenna receiving the navigation signal in order to sample the range data at the positioning unit.

9. A navigation signal receiving method for determining a position based on a navigation signal sent from an artificial satellite, the method comprising:
sampling range data from the navigation signal at a first time interval;
averaging the range data at a second time interval of a lower rate than the first time interval; and
calculating a position based on the range data averaged.

10. The navigation signal receiving method according to claim 9, wherein the first time interval is a time interval that reduces positioning errors caused by multipath waves exhibiting oscillating behavior.

11. The navigation signal receiving method according to claim 9, wherein the second time interval is a time interval that allows a mobile station to be tracked.

12. The navigation signal receiving method according to claim 11, wherein the mobile station is used for navigation.

13. The navigation signal receiving method according to claim 9, wherein the first time interval is several hundreds Hz or greater.

14. The navigation signal receiving method according to claim 9, wherein the second time interval is 10 Hz or smaller.

15. The navigation signal receiving method according to claim 9, wherein the first time interval is several tens times or greater than the second time interval.

16. The navigation signal receiving method according to claim 9, further comprising:
receiving the navigation signal to sample the range data at the first time interval.
